(19) United States
(12) Patent Application Publication
(10) Pub. No.: US 2007/0296863 A1
(43) Pub. Date: Dec. 27, 2007

(54) Method, medium, and system processing video data

(75) Inventors: Doo Sun Hwang, Seoul (KR); Jung Bae Kim, Yongin-si (KR); Won Jun Hwang, Seoul (KR); Ji Yeun Kim, Seoul (KR); Young Su Moon, Seoul (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/647,438

(22) Filed: Dec. 29, 2006

(30) Foreign Application Priority Data
Jun. 12, 2006 (KR) 10-2006-0052724

(51) Int. Cl. H04N 5/445

(52) U.S. Cl. 348/563

(57) ABSTRACT

A video data processing system including a clustering unit to generate a plurality of clusters by grouping a plurality of shots forming video data, the grouping being based on a similarity between the plurality of shots, and a final cluster determiner to identify a cluster having the greatest number of shots from the plurality of clusters to be a first cluster and determining a final cluster by comparing other clusters with the first cluster.

### CROSS-REFERENCE TO RELATED APPLICATIONS

This application claims priority from Korean Patent Application No. 10-2006-0052724, filed on Jun. 12, 2006, in the Korean Intellectual Property Office, the disclosure of which is incorporated herein by reference.

### BACKGROUND OF THE INVENTION

1. Field of the Invention

One or more embodiments of the present invention relate at least to a method, medium, and system processing video data, and more particularly, to a method, medium, and system providing face feature information in video data and segmenting video data based on a same face clip being repeatedly shown.

2. Description of the Related Art

As data compression and transmission technologies have developed, an increasing amount of multimedia data is generated and transmitted on the Internet. With such, it is difficult to search multimedia data for particular information desired by users from the large amount of multimedia data available on the Internet. Further, many users desire that only relevant or filtered information to initially be shown, such as through a summarization of the multimedia data. In response to such desires, various techniques for generating summaries for multimedia data have been suggested.

For news video data, segmentation information with respect to a plurality of news segments is typically included in one collection of video data. Accordingly, users can readily be provided the described news video data segmented for each news segment. In this regard, there are a number of provided conventional methods of segmenting and summarizing news video data.

For example, in one conventional technique, the video data is segmented based on a video/audio feature model of a news anchor shot. In another conventional technique, face/voice data of an anchor is stored in a database and a shot, determined to include the anchor, is detected from video data, thereby segmenting the video data. Here, the term shot can be representative of a series of temporally related frames for a particular news segment that has a common feature or substantive topic, for example.

However, the method of summarization and shot detection based on a video/audio feature model of an anchor shot from such conventional techniques of segmenting and summarizing video data cannot be used when the video/audio feature included in video data does not have a certain known or predetermined form. Further, in the conventional technique of using the face/voice data of the anchor, a scene in which an anchor and a guest stored in the database are repeatedly shown may be easily segmented. However, the scene that includes an anchor and a guest not stored in the database repeatedly shown cannot be segmented.

In addition, in another conventional technique, a scene which alternates between showing an anchor and showing a guest, for one theme, which should not be segmented, is conventionally segmented. For example, when an anchor is communicating with a guest while reporting one new topic, since this portion represents the same topic it should be maintained as one unit. However, in conventional techniques, a series of shots in which the anchor is shown and then the guest is shown are separated into completely different units and segmented accordingly.

Thus, the inventors have found a need for a method, medium, and system segmenting/summarizing video data by using a semantic unit without previously storing face/voice data with respect to a certain anchor in a database, and which can be applied to video data that does not include a predefined video/audio feature. In addition, it has further been found desirable for a video data summarization method in which a scene where an anchor and a guest are repeatedly shown within one theme is not segmented.

### SUMMARY OF THE INVENTION

One or more embodiments of the present invention provide a video data processing method, medium, and system capable of segmenting video data by a semantic unit that does not include a known video/audio feature.

One or more embodiments of the present invention further provide a video data processing method, medium, and system capable of segmenting/summarizing video data according to a semantic unit, without previously storing face/voice data with respect to a known anchor in a database.

One or more embodiments of the present invention further provide a video data processing method, medium, and system which does not segment scenes in which an anchor and a guest are repeatedly shown in one theme.

One or more embodiments of the present invention further provide a video data processing method, medium, and system capable of segmenting video data for each anchor, namely, each theme, by using a fact that an anchor is repeatedly shown, equally spaced in time, more than other characters.

One or more embodiments of the present invention further provide a video data processing method, medium, and system capable of segmenting video data by identifying an anchor by removing a face shot including a character shown alone, from a cluster.

One or more embodiments of the present invention further provide a video data processing method, medium, and system capable of precisely segmenting video data by using a face model generated in a process of segmenting the video data.

Additional aspects and/or advantages of the invention will be set forth in part in the description which follows and, in part, will be apparent from the description, or may be learned by practice of the invention.

To achieve the above aspects and/or advantages, embodiments of the present invention include a video data processing system, including a clustering unit to generate a plurality of clusters by grouping a plurality of shots forming video data, the grouping of the plurality of shots being based on similarities among the plurality of shots, and a final cluster determiner to identify a cluster having a greatest number of shots from the plurality of clusters to be a first cluster and identifying a final cluster by comparing other clusters with the first cluster.

To achieve the above aspects and/or advantages, embodiments of the present invention include a method of processing video data, including calculating a first similarity among a plurality of shots forming the video data, generating a plurality of clusters by grouping shots whose first similarity is not less than a predetermined threshold, selectively merging the plurality of shots based on a second similarity among the plurality of shots, identifying a cluster including a greatest number of shots from the plurality of clusters, to be a first cluster, identifying a final cluster by comparing the first cluster with clusters excluding the first cluster, and extracting shots included in the final cluster.

To achieve the above aspects and/or advantages, embodiments of the present invention include a method of processing video data, including calculating similarities among a plurality of shots forming the video data, generating a plurality of clusters by grouping shots whose similarity is not less than a predetermined threshold, merging clusters including a same shot, from the generated plurality of clusters, and removing a cluster from the merged clusters whose number of included shots is not more than a predetermined value.

To achieve the above aspects and/or advantages, embodiments of the present invention include a method of processing video data, including segmenting the video data into a plurality of shots, identifying a key frame for each of the plurality of shots, comparing a key frame of a first shot selected from the plurality of shots with a key frame of an Nth shot after the first shot, and merging the first shot through the Nth shot when similarities among the key frame of the first shot and the key frame of the Nth shot is not less than a predetermined threshold.

To achieve the above aspects and/or advantages, embodiments of the present invention include a method of processing video data, including segmenting the video data into a plurality of shots, generating a plurality of clusters by grouping the plurality of shots, the grouping being based on similarities among the plurality of shots, identifying a cluster including a greatest number of shots from the plurality of clusters, to be a first cluster, identifying a final cluster by comparing the first cluster with clusters excluding the first cluster, and extracting shots included in the final cluster.

To achieve the above aspects and/or advantages, embodiments of the present invention include at least one medium including computer readable code to control at least one processing element to implement a method of processing video data, the method including calculating a first similarity among a plurality of shots forming the video data, generating a plurality of clusters by grouping shots whose first similarity is not less than a predetermined threshold, selectively merging the plurality of shots based on a second similarity among the plurality of shots, identifying a cluster including a greatest number of shots from the plurality of clusters, to be a first cluster, identifying a final cluster by comparing the first cluster with clusters excluding the first cluster, and extracting shots included in the final cluster.

To achieve the above aspects and/or advantages, embodiments of the present invention include at least one medium including computer readable code to control at least one processing element to implement a method of processing video data, the method including calculating similarities among a plurality of shots forming the video data, generating a plurality of clusters by grouping shots whose similarity is not less than a predetermined threshold, merging clusters including a same shot, from the generated plurality of clusters, and removing a cluster from the merged clusters whose number of included shots is not more than a predetermined value.

To achieve the above aspects and/or advantages, embodiments of the present invention include at least one medium including computer readable code to control at least one processing element to implement a method of processing video data, the method including segmenting the video data into a plurality of shots, identifying a key frame for each of the plurality of shots, comparing a key frame of a first shot selected from the plurality of shots with a key frame of an Nth shot after the first shot, and merging the first shot through the Nth shot when similarities among the key frame of the first shot and the key frame of the Nth shot is not less than a predetermined threshold.

To achieve the above aspects and/or advantages, embodiments of the present invention include at least one medium including computer readable code to control at least one processing element to implement a method of processing video data, the method including segmenting the video data into a plurality of shots, generating a plurality of clusters by grouping the plurality of shots, the grouping being based on similarities among the plurality of shots, identifying a cluster including a greatest number of shots from the plurality of clusters, to be a first cluster, identifying a final cluster by comparing the first cluster with clusters excluding the first cluster, and extracting shots included in the final cluster.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a video data processing system, according to an embodiment of the present invention;

FIG. 2 illustrates a video data processing method, according to an embodiment of the present invention;

FIG. 3 illustrates a frame and a shot in video data;

FIGS. 4A and 4B illustrate a face detection method, according to an embodiment of the present invention;

FIGS. 5A, 5B, and 5C illustrates an example of a simple feature implemented according to an embodiment of the present invention;

FIGS. 5D and 5E illustrates an example of a simple feature applied to a face image;

FIG. 6 illustrates a face detection method, according to an embodiment of the present invention;

FIG. 7 illustrates a face feature information extraction method, according to an embodiment of the present invention;

FIG. 8 illustrates a plurality of classes distributed in a Fourier domain;

FIG. 9A illustrates a low frequency band;

FIG. 9B illustrates a frequency band beneath an intermediate frequency band;

FIG. 9C illustrates an entire frequency band including a high frequency band;

FIGS. 10A and 10B illustrate a method of extracting face feature information from sub-images having different distances between eyes, according to an embodiment of the present invention;

FIG. 11 illustrates a method of clustering, according to an embodiment of the present invention;

FIGS. 12A, 12B, 12C, and 12D illustrate clustering, according to an embodiment of the present invention;

FIGS. 13A and 13B illustrate shot mergence, according to an embodiment of the present invention;

FIGS. 14A, 14B, and 14C illustrate an example of merging shots by using a search window, according to an embodiment of the present invention;

FIG. 15 illustrates a method of generating a final cluster, according to an embodiment of the present invention; and

FIG. 16 illustrates a process of merging clusters by using time information of shots, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

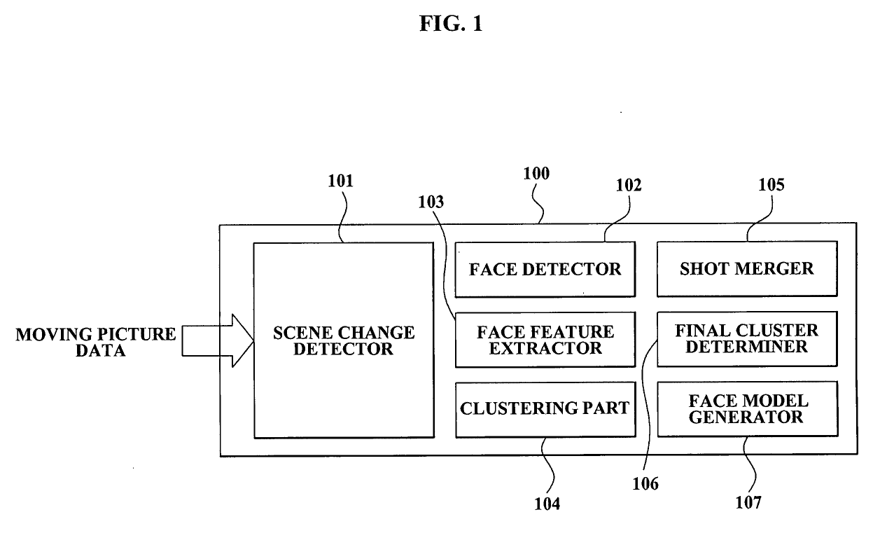

FIG. 1 illustrates a video data processing system 100, according to an embodiment of the present invention. Referring to FIG. 1, the video data processing system 100 may include a scene change detector 101, a face detector 102, a face feature extractor 103, a clustering unit 104, a shot merging unit 105, a final cluster determiner 106, and a face model generator 107, for example.

The scene change detector 101 may segment video data into a plurality of shots and identify a key frame for each of the plurality of shots. Here, any use of the term “key frame” is a reference to an image frame or merged data from multiple frames that may be extracted from a video sequence to generally express the content of a unit segment, i.e., a frame capable of best reflecting the substance within that unit segment/shot. Thus, the scene change detector 101 may detect a scene change point of the video data and segment the video data into the plurality of shots. Here, the scene change detector 101 may detect the scene change point by using various techniques such as those discussed in U.S. Pat. Nos. 5,767,922, 6,137,544, and 6,393,054. According to an embodiment of the present invention, the scene change detector 101 calculates similarity for a histogram of two sequential frame images, namely, a present frame image and a previous frame image in a color histogram and detects the present frame as a frame in which a scene change occurs when the calculated similarity is less than a certain threshold, noting that alternative embodiments are equally available.

As noted above, the key frame is one or a plurality of frames selected from each of the plurality of shots and may represent the shot. In an embodiment, since the video data is segmented by determining a face image feature of an anchor, a frame capable of best reflecting a face feature of the anchor may be selected as the key frame. According to an embodiment of the present invention, the scene change detector 101 selects a frame separated from the scene change point at a predetermined interval, from frames forming each shot. Namely, the scene change detector 101 identifies a frame, after a predetermined amount of time from a start frame of the each of the plurality of shots, as the key frame of the shot. This is because a few angles of the face of the anchor after the start frame do not face the front side, and it is often difficult to acquire a clear image from the start frames. For example, the key frame may be a frame 0.5 seconds after each scene change point.

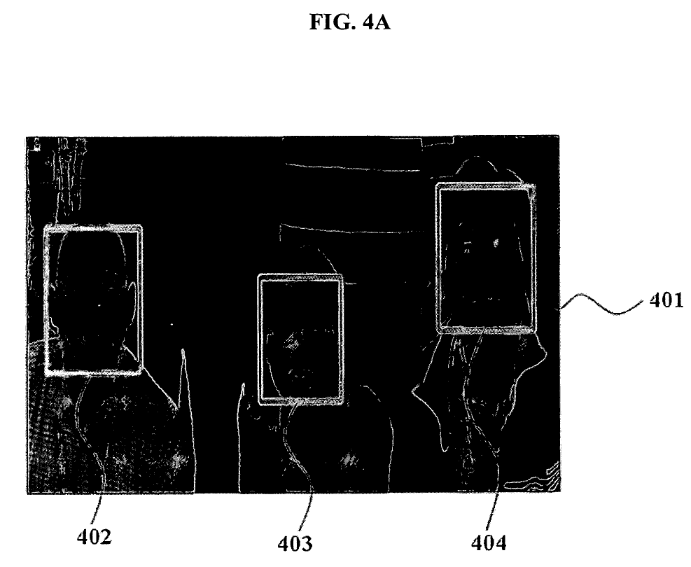

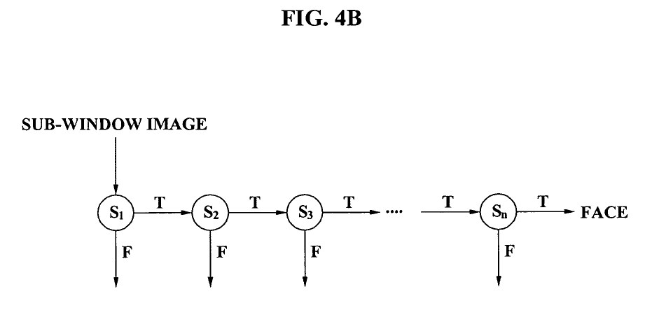

Thus, the face detector 102 may detect a face from the key frame. Here, the operations performed by the face detector 102 will be described in greater detail further below referring to FIGS. 4 through 6.

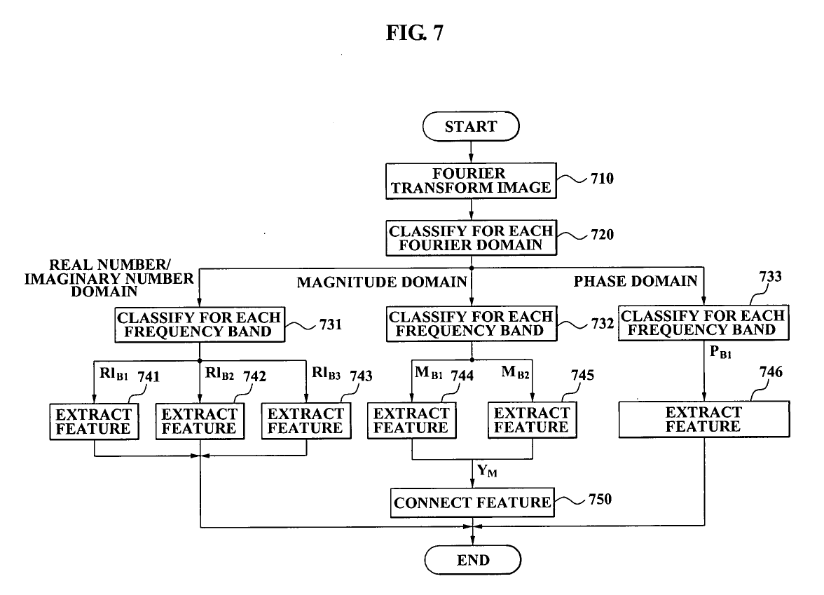

The face feature extractor 103 may extract face feature information from the detected face, e.g., by generating multi-sub-images with respect to an image of the detected face, extracting Fourier features for each of the multi-sub-images by Fourier transforming the multi-sub-images, and generating the face feature information by combining the Fourier features. The operations performed by the face feature extractor 103 will be described in greater detail further below referring to FIGS. 7 through 10.

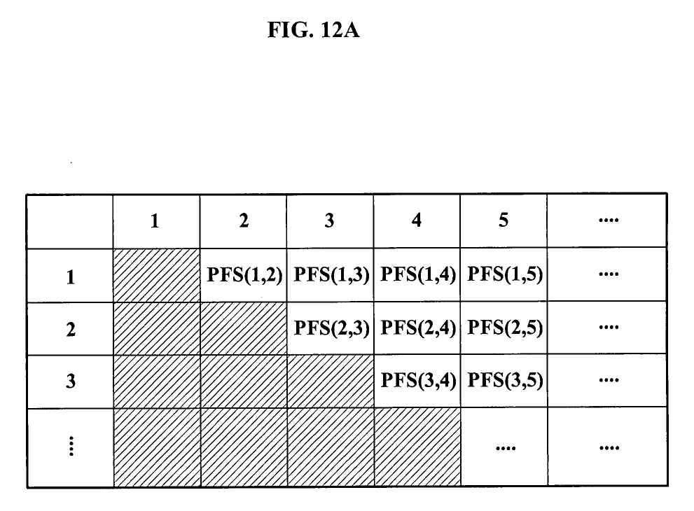

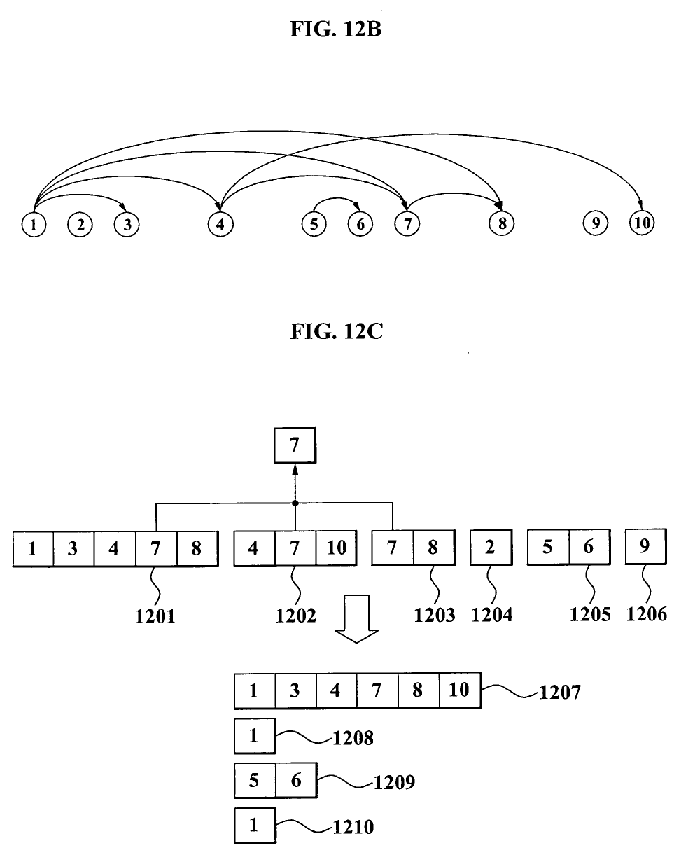

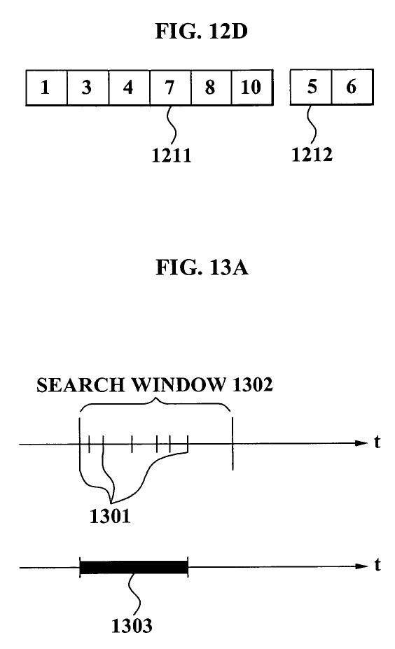

The clustering unit 104 may generate a plurality of clusters, by grouping a plurality of shots forming video data, based on similarity between the plurality of shots. The clustering unit 104 may further merge clusters including the same shot from the generated clusters and remove clusters whose shots are not more than a predetermined number. The operations performed by the clustering unit will be described in greater detail further below referring to FIGS. 11 and 12.

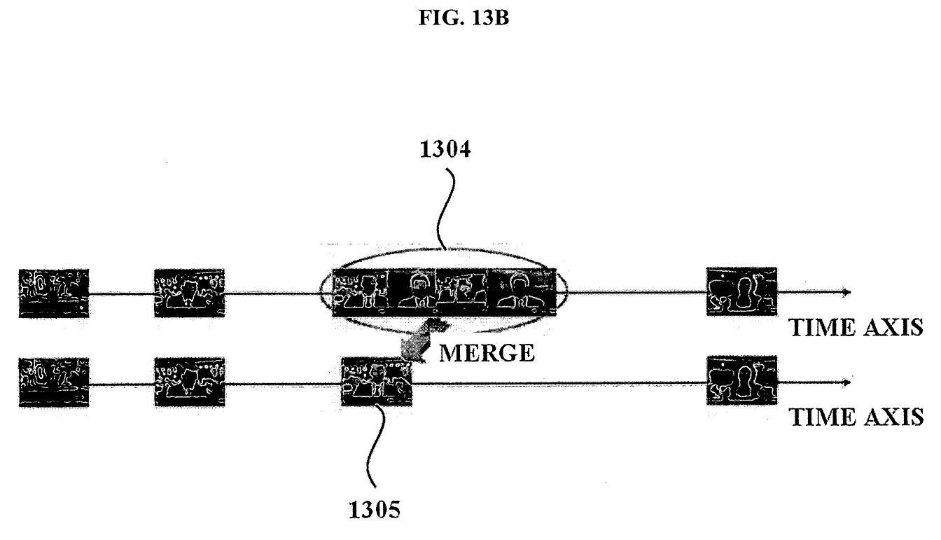

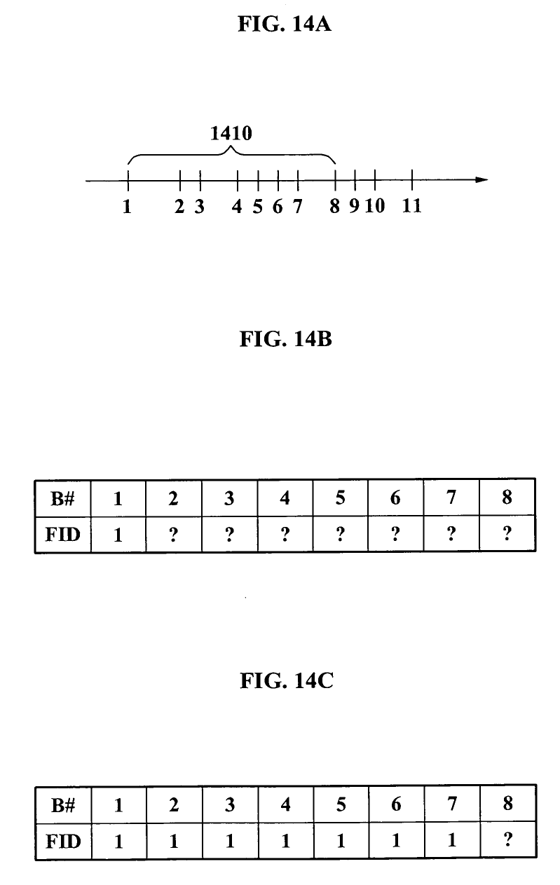

The shot merging unit 105 may merge a plurality of shots that are repeatedly included in a search window more times than a predetermined number of times and within a predetermined amount of time, into one shot, by applying the search window on the video data. Here, the shot merging unit 105 may identify the key frame for each of the plurality of shots, compare a key frame of a first shot selected from the plurality of shots with a key frame of an Nth shot after the first shot, and merge all the shots from the first shot to the Nth shot when similarity between the key frame of the first shot and the key frame of the Nth shot is not less than a predetermined threshold. In this example, the size of the search window is N. When the similarity between the key frame of the first shot and the key frame of the Nth shot is less than the predetermined threshold, the shot merging unit 105 may compare the key frame of the first shot with a key frame of an N−1th shot. Namely, in one embodiment, a first shot is compared with a final shot by a search window whose size is N, and when the first shot is determined to be not similar to the final shot, a next shot is compared with the first shot. As described above, according to an embodiment of the present invention, shots included in a scene in which an anchor and a guest are repeatedly shown in one theme may be efficiently merged. The operations performed by the shot merging unit 105 will be described in greater detail further below referring to FIGS. 13 and 14.

The final cluster determiner 106 may identify the cluster having the largest number of shots, from the plurality of clusters, to be a first cluster and identify a final cluster by comparing other clusters with the first cluster. The final cluster determiner 106 may then identify the final cluster by merging the clusters by using time information of the shots included in the cluster.

The final cluster determiner 106 may further perform a second operation of generating a first distribution value of time lags between shots included in the first cluster whose number of key frames is largest in the clusters, sequentially merge shots included in other clusters excluding the first cluster from the clusters with the first cluster, and identify a smallest value from distribution values of the merged cluster to be a second distribution value. Further, when the second distribution value is less than the first distribution value, the final cluster determiner 106 may merge the cluster identified to be the second distribution value with the first cluster and identify the final cluster after performing the merging for all the clusters. However, when the second distribution value is greater than the first distribution value, the final cluster is identified without performing the second cluster mergence.

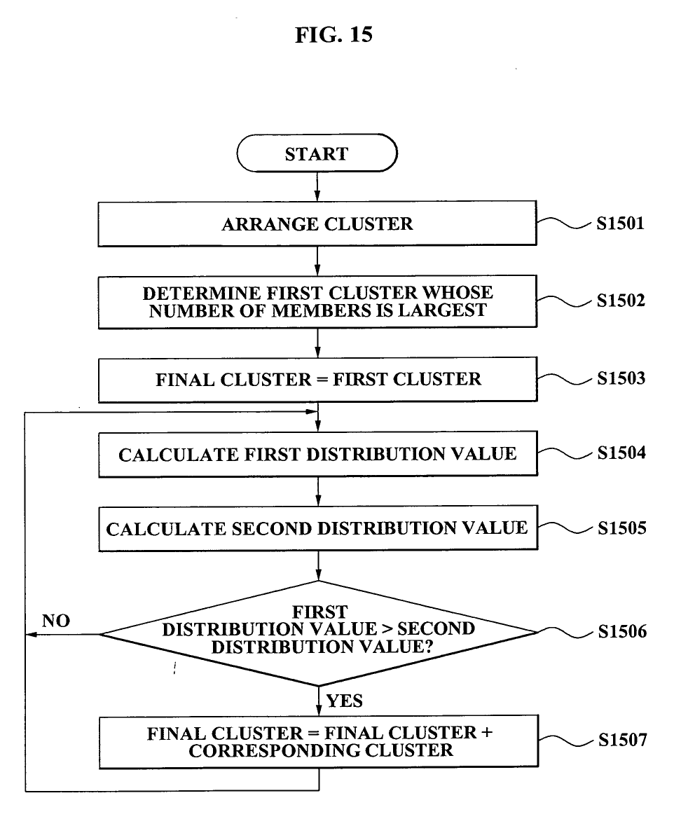

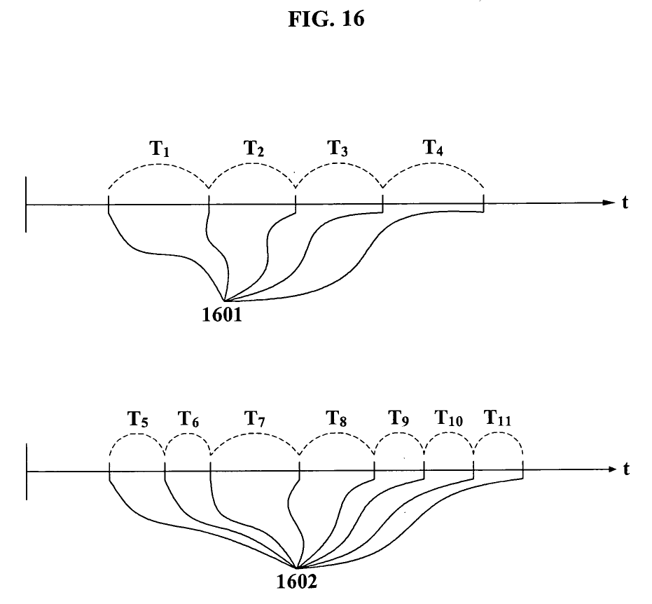

The final cluster determiner 106, thus, may identify the shots included in the final cluster to be a shot in which an anchor is included. According to an embodiment of the present invention, the video data is segmented by using the shots identified to be the shot in which the anchor is included, as a unit semantic. The operations performed by the final cluster determiner 106 will be described in greater detail further below referring to FIGS. 15 and 16.

The face model generator 107 may identify a shot that is most often included from the shots included in a plurality of clusters identified to be the final cluster, to be a face model shot. A character shown in a key frame of the face mode shot may be identified to be an anchor of news video data. Thus, according to an embodiment of the present invention, the news video data may be segmented by using an image of the character identified to be the anchor.

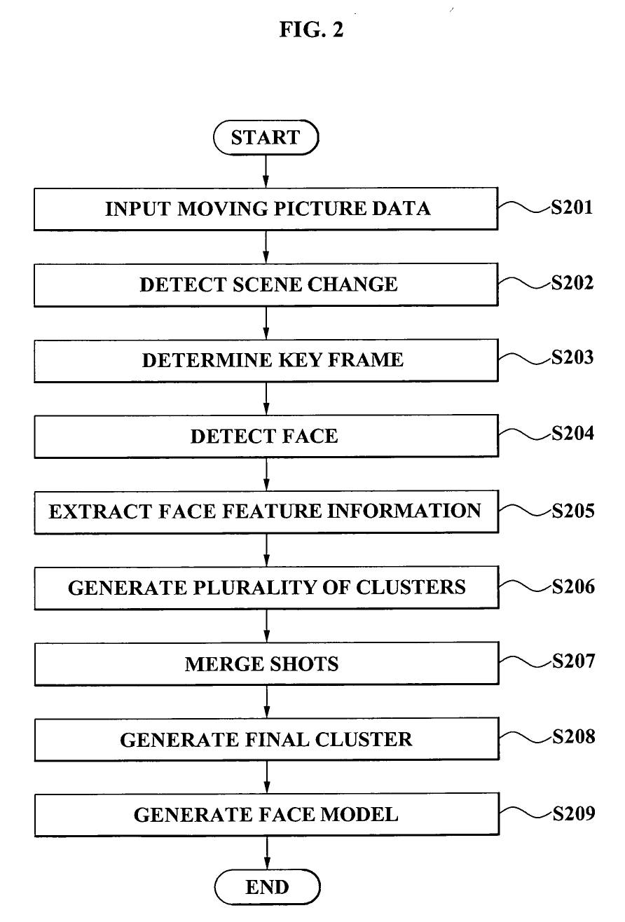

FIG. 2 illustrates a video data processing method, according to an embodiment of the present invention.

In an embodiment, the video data may include data including both video data with audio data and data including video data without audio data. When video data is input, the video data processing system 100 may segment the video data into video data and audio data and transfer the video data to the scene change detector 101, for example, in operation S201.

In operation S202, the scene change detector 101 may detect a scene change point of video data and segment the video data into a plurality of shots based on the scene change point.

In one embodiment, the scene change detector 101 stores a previous frame image, calculates a similarity with respect to a color histogram between two sequential frame images, namely, a present frame image and a previous frame image, and detects the present frame as a frame in which the scene change occurs when the similarity is less than a certain threshold. In this case, similarity (Sim(Hₜ, Hₜ₊₁)) may be calculated as in the below Equation 1.

$$\text{Equation} 1 \text{:}$$

$$Sim ( {H}_{t} , {H}_{t + 1} ) = {\sum }_{n = 1}^{N} min [ {H}_{t} ( n ) , {H}_{n + 1} ( n ) ]$$

In this case, Hₜ indicates a color histogram of the previous frame image, Hₜ₊₁ indicates a color histogram of the present frame image, and N indicates a histogram level.

In an embodiment, a shot indicates a sequence of video frames acquired from one camera without an interruption and is a unit for analyzing or forming video. Thus, a shot includes a plurality of video frames. Also, a scene is generally made up of a plurality of shots. The scene is a semantic unit of the generated video data. The described concept of the shot and the scene may be identically applied to audio data as well as video data, depending on embodiments of the present invention.

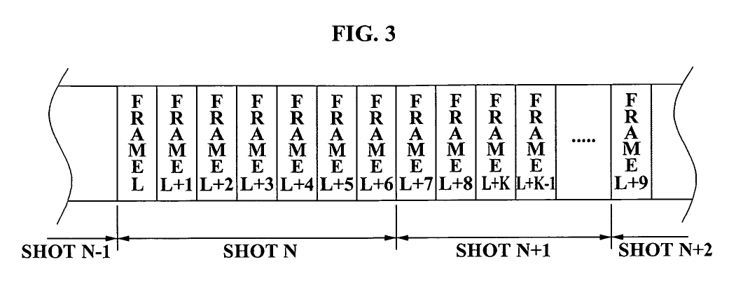

A frame and a shot in video data will now be described by referring to FIG. 3. In FIG. 3, frames from L to L+6 form a shot N and frames from L+7 to L+K−1 form a shot N+1. Here, a scene is changed between frames L+6 and L+7. Further, the shots N and N+1 form a scene M. Namely, the scene is a group of one or more sequential shots, and the shot is a group of one or more sequential frames.

Accordingly, when a scene change point is detected, the scene change detector 101, for example, identifies a frame separated from the scene change point at a predetermined interval, to be a key frame, in operation S203. Specifically, the scene change detector 101 may identify a frame after a predetermined amount of time from a start frame of each of the plurality of shots to be a key frame. For example, a frame 0.5 seconds after detecting the scene change point is identified to be the key frame.

In operation S204, the face detector 102, for example, may detect a face from the key frame, with various methods available such detecting, such that the face detector 102 may segment the key frame into a plurality of domains and may determine whether a corresponding domain includes the face, with respect to the segmented domains. The identifying of the face domain may be performed by using appearance information of an image of the key frame. The appearance may include, for example, a texture and a shape. According to another embodiment of the present invention, the contour of the image of the frame may be extracted and whether the face is included may be determined based on the color information of pixels in a plurality of closed curves generated by the contour.

When the face is detected from the key frame, in operation S205, the face feature extractor 103, for example, may extract and store face feature information of the detected face in a predetermined storage, for example. In this case, the face feature extractor 103 may identify the key frame from which the face is detected to be a face shot. The face feature information can be associated with features capable of distinguishing faces, and various techniques may be used for extracting the face feature information. Such techniques include extracting face feature information from various angles of a face, extracting colors and patterns of skin, analyzing the distribution of elements that are features of the face, e.g., a left eye and a right eye forming the face and a space between both eyes, and using frequency distribution of pixels forming the face. In addition, additional techniques discussed in Korean Patent Application Nos. 10-2003-770410 and 10-2004-061417 may be used as such techniques for extracting face feature information and for determining similarities of a face by using face feature information.

In operation 206, the clustering unit 104, for example, may calculate similarities between faces included in the face shots by using the extracted face feature information, and generate a plurality of clusters by grouping face shots whose similarity is not less than a predetermined threshold. In this case, each of the face shots may be repeatedly included in several clusters. For example, one face shot may be included in a first cluster and a fifth cluster.

To merge face shots including a different anchor, the shot merging unit 105, for example, may merge clusters by using the similarities between the face shots included in the cluster, in operation S207.

The final cluster determiner 106, for example, may generate a final cluster including only shots determined to include an anchor from the face shots included in the clusters by statistically determining an interval of when the anchor appears, in operation S208.

In this case, the final cluster determiner 106 may calculate a first distribution value of time lags between face shots included in a first cluster whose number of face shots is greatest from the clusters and identifies a smallest value from distribution values of the merged clusters by sequentially merging the face shots included in other clusters excluding the first cluster, with the first cluster, to be a second distribution value. Further, when the second distribution value is less than the first distribution value, a cluster identified to be the second distribution value is merged with the first cluster and the final cluster is generated after the merging of all the clusters. However, when the second distribution value is greater than the first distribution value, the final cluster is generated without the merging of the second cluster.

In operation S209, the face model generator 107, for example, may identify a shot, which is most often included from the shots included in a plurality of clusters that is identified to be the final cluster, to be a face model shot. The person in the face model shot may be identified to be a news anchor, e.g., because a news anchor is a person who appears a greatest number of times in a news program.

FIGS. 4A and 4B illustrate a face detection method, according to an embodiment of the present invention.

As shown in FIG. 4A, the face detector 102 may apply a plurality of sub-windows 402, 403, and 404 with respect to a key frame 401 and determine whether images located in the sub-windows include faces.

As shown in FIG. 4B, the face detector 102 may include n number of cascaded stages S₁ through Sₙ. In this case, each of the stages S₁ through Sₙ may detect a face by using a simple feature-based classifier. For example, a first stage S₁ may use four or five classifiers and a second stage S₂ may use fifteen to twenty classifiers. The further along the stage is, the greater a number of classifiers that may be implemented.

In this embodiment, each stage may be formed of a weighted sum with respect to a plurality of classifiers and may determine whether the face is detected, according to a sign of the weighted sum. Each stage may be represented as in Equation 2, set forth below.

$$\text{Equation} 2 \text{:}$$

$$\text{sign} [ {\sum }_{m = 1}^{M} {c}_{m} \cdot {f}_{m} ( x ) ]$$

In this case, cₘ indicates a weight of a classifier, and fₘ(x) indicates an output of the classifier. The fₘ(x) may be shown as in Equation 3, set forth below.

fₘ(x)ε{−1,1} 3

Namely, each classifier may be formed of one simple feature and a threshold and output a value of −1 or 1, for example.

Referring to FIG. 4B, the first stage S₁ may attempt to detect a face by using a Kth sub-window image of a first image or a second image as an input, determine the Kth sub-window image to be a non-face when face detection fails, and determine the Kth sub-window image to be the face when the face detection is successful. On the other hand, an AdaBoost-based learning algorithm may be used for each classifier and selecting of a weight. According to the AdaBoost algorithm, several critical visual features are selected from a large-sized feature set to generate a very efficient classifier. The AdaBoost algorithm is described in detail in “A decision-theoretic generalization of on-line learning and an application to boosting”, In Computational Learning Theory: Eurocolt '95, pp. 23-37, Springer-Verlag, 1995, by Yoav Freund and Robert E. Schapire.

According to the staged structure, connected by the cascaded stages, since determination is possible even when a small number of simple features is used, the non-face is quickly rejected in initial stages, such as a first stage or a second stage, and face detection may be attempted by receiving a k+1th sub-window image, thereby improving full face detection processing speed.

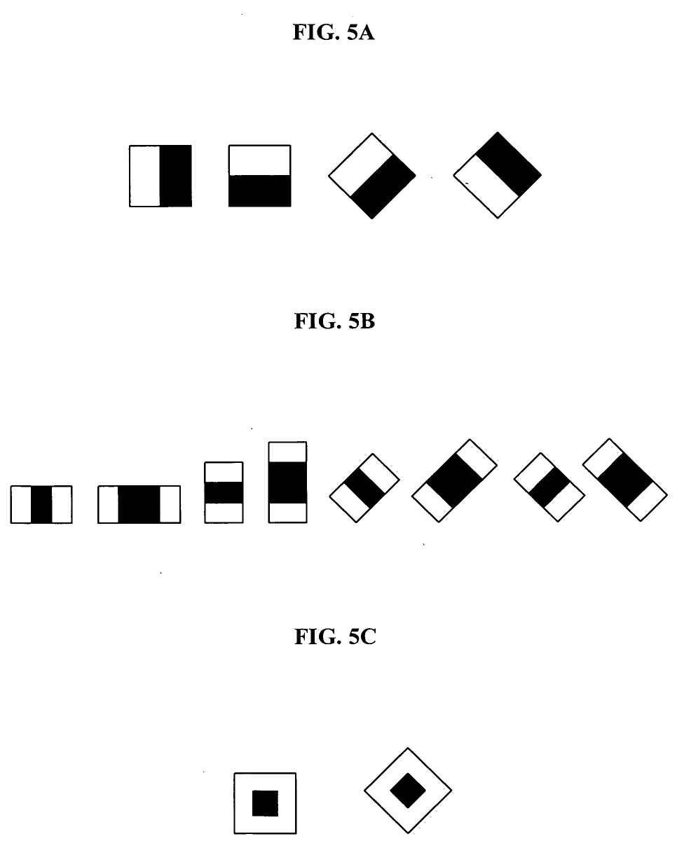

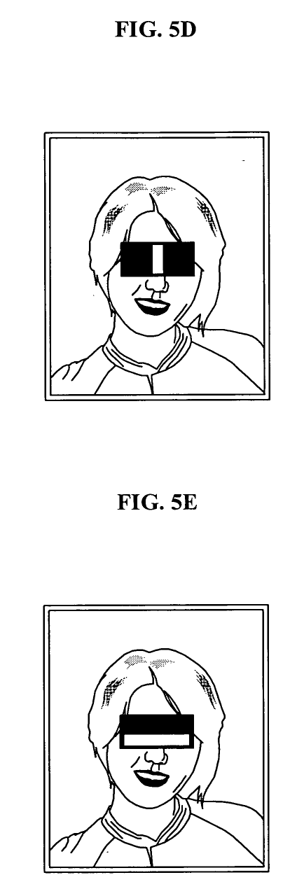

FIGS. 5A, 5B, and 5C illustrate an example of a simple feature applied to the present invention. FIG. 5A illustrates an edge simple feature, FIG. 5B illustrates a line simple feature, and FIG. 5C illustrates a center-surround simple feature, with each of the simple features being formed of two or three white or black rectangles. According to the simple feature, each classifier subtracts a summation of gray scale values of pixels located in a white square from a summation of gray scale values of pixels located in a black square and compares the subtraction result with a threshold corresponding to the simple feature. A value of 1 or −1 may then be output according to the comparison result.

FIG. 5D illustrates an example for detecting eyes by using a line simple feature formed of one white square and two black squares. Considering that the eye domains are darker than the domain of the bridge of the nose, the difference of gray scale values between the eye domain and the domain of the bridge of the nose can be measured. FIG. 5E further illustrates an example for detecting the eye domain by using the edge simple feature formed of one white square and one black square. Considering that the eye domain is darker than a cheek domain, the difference of gray scale values between the eye domain and the domain of an upper part of the cheek can be measured. As described above, the simple features for detecting the face may vary greatly.

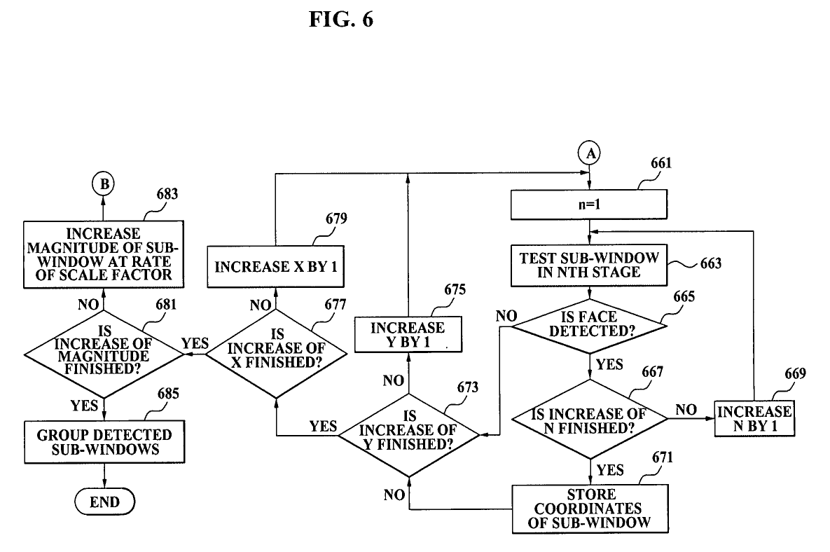

FIG. 6 illustrates a face detection method, according to an embodiment of the present invention.

In operation 661, a number of a stage may be established as 1, and in operation 663, a sub-window image may be tested in an nth stage to attempt to detect a face. In operation 665, whether face detection in the nth stage is successful may be determined and operation 673 may further be performed to change the location or magnitude of the sub-window image when such face detection fails. However, when the face detection is successful, in operation 667, whether the nth stage is a final stage may be determined by the face detector 102. Here, when the nth stage is not the final stage, in operation 669, n is increased by 1 and operation 663 is repeated. Conversely, when the nth stage is the final stage, in operation 671, coordinates of the sub-window image may be stored.

In operation 673, whether y is corresponding to h of a first image or a second image, namely, whether an increasing of y is finished, may be determined. When the increasing of y is finished, in operation 677, whether x is corresponding to w of the first image or the second image, namely, whether an increasing of x is finished may be determined. Conversely, when the increasing of y is not finished, in operation 675, y may be increased by 1 and operation 661 repeated. When the increasing of x is finished, operation 681 may be performed. When the increasing of x is not finished, in operation 679, y is maintained as is, x is increased by 1, and operation 661 repeated.

In operation 681, whether an increase of magnitude of the sub-window image is finished may be determined. When the increase of the magnitude of the sub-window image is not finished, in operation 683, the magnitude of the sub-window image may be increased at a predetermined scale factor rate and operation 661 repeated. Conversely, when the increase of the magnitude of the sub-window image is finished, in operation 685, coordinates of each sub-window image from which the stored face is detected in operation 671 may be grouped.

In a face detection method, according to an embodiment of the present invention, as a method of improving detection speed, a restricting of a full frame image input to the face detector 102, namely, a restricting of a total number of sub-window images detected as the face from one first image may be performed. Similarly, a magnitude of a sub-window image may be restricted to “magnitude of a face detected from a previous frame image—(n×n) pixels” or a magnitude of the second image to a predetermined multiple of coordinates of a box of a face position detected from the previous frame image.

FIG. 7 illustrates a face feature information extraction method, according to an embodiment of the present invention. According to this face feature information extraction method, multi-sub-images with respect to an image of a face detected by the face detector 102 are generated, Fourier features for each of the multi-sub-images are extracted by Fourier transforming the multi-sub-images, and the face feature information is generated by combining the Fourier features. The multi-sub-images may have the same size and with respect to the same image of the detected face, but distances between eyes in the multi-sub-images may be different.

The face feature extractor 103 may generate sub-images having a different eye distance, with respect to an input image. The sub-images may have the same size of 45×45 pixels, for example, and have different distances from eye to the same face image.

A Fourier feature may be extracted for each of the sub-images. Here, there may be four operations, including a first operation, where multi-sub-images are Fourier transformed, a second operation, where a result of Fourier transform is classified for each Fourier domain, a third operation, where a feature is extracted by using a corresponding Fourier component for each classified Fourier domain, and a fourth operation, where the Fourier features are generated by connecting all features extracted for each Fourier domain. In the third operation, the feature can be extracted by using the Fourier component corresponding to a frequency band classified for each of the Fourier domain. The feature is extracted by multiplying a result of subtracting an average Fourier component of a corresponding frequency band from the Fourier component of the frequency band, by a previously trained transformation matrix. The transformation matrix can be trained to output the feature when the Fourier component is input according to a principal component and linear discriminant analysis (PCLDA) algorithm, for example. Hereinafter, such an algorithm will be described in detail.

The face feature extractor 103 Fourier transforms an input image as in Equation 4 (operation 710), set forth below.

$$\text{Equation} 4 \text{:}$$

$$F ( u , v ) = \frac{1}{MN} {\sum }_{x = 0}^{M - 1} {\sum }_{y = 0}^{N - 1} χ ( x , y ) exp [ - j2π ( \frac{ux}{M} + \frac{vy}{N} ) ]$$

$$0 \leq u \leq ( M - 1 ) 0 \leq v \leq ( N - 1 )$$

In this case, M is the number of pixels in the direction of an x axis in the input image, N is the number of pixels in the direction of a y axis, and X(x,y) is the pixel value of the input image.

The face feature extractor 103 may classify a result of a Fourier transform according to Equation 4 for each domain by using the below Equation 5, in operation 720. In this case, the Fourier domain may be classified into a real number component R(u,v), an imaginary number component I(u,v), a magnitude component |F(u,v)|, and a phase component φ(u,v) of the Fourier transform result, expressed as in Equation 5, set forth below.

$$\text{Equation} 5 \text{:}$$

$$F ( u , v ) = R ( u , v ) + jI ( u , v )$$

$$\vert F ( u , v ) \vert = {[ {R}^{2} ( u , v ) + {I}^{2} ( u , v ) ]}^{1 / 2}$$

$$φ ( u , v ) = {tan}^{- 1} [ \frac{I ( u , v )}{R ( u , v )} ]$$

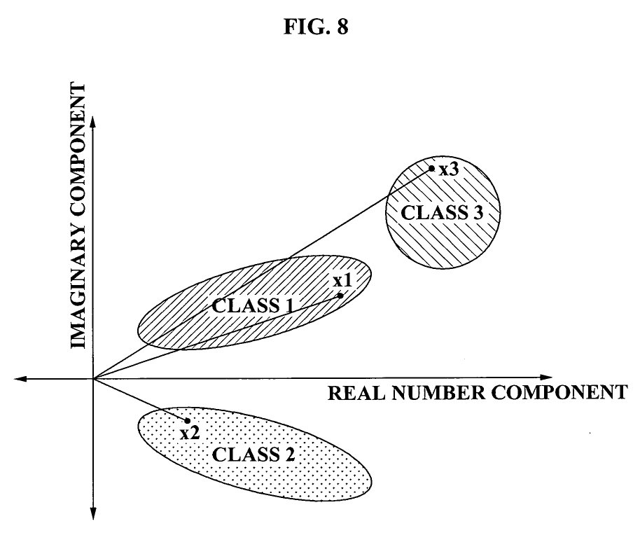

FIG. 8 illustrates a plurality of classes, as distributed in a Fourier domain. As shown in FIG. 8, the input image may be classified for each domain because distinguishing a class to which a face image belongs may be difficult when considering only one of the Fourier domains. In this case, the illustrated classes indicate spaces of the Fourier domain occupied by a plurality of face images corresponding to one person.

For example, it may be known that while distinguishing class 1 from class 3, with respect to phase, is relatively difficult, while distinguishing the class 1 from the class 3 with respect to magnitude is relatively simple. Similarly, while it is difficult to distinguish class 1 from class 2 with respect to magnitude, the class 1 may be distinguished from the class 2 with respect to phase relatively easily. Thus, in FIG. 8, points x₁, x₂, and X₃ express examples of a feature included in each class. Referring to FIG. 8, it is known that classifying classes by reflecting all the Fourier domains is more advantageous for face recognition.

In the case of general template-based face recognition, a magnitude domain, namely, a Fourier spectrum, may be substantially used in describing a face feature because while phase is drastically changed magnitude is only gently changed when a small spatial displacement occurs. However, in an embodiment of the present embodiment, while a phase domain showing a notable feature with respect to the face image is reflected, a phase domain of a low frequency band, relatively less sensitive, is also considered together with the magnitude domain. Further, to reflect all detailed features of a face, a total of three Fourier features may be used for performing the face recognition. As the Fourier features, a real/imaginary (R/I) domain combining a real number component/imaginary number component (hereinafter, referred to as an R/I domain), a magnitude component of Fourier (hereinafter, referred to as an M domain), and a phase component of Fourier (hereinafter, referred to as a P domain) may be used. Mutually different frequency bands may be selected corresponding to properties of the described various face features.

The face feature extractor 103 may classify each Fourier domain for each frequency band, e.g., in operations 731, 732, and 733. Namely, the face feature extractor 103 may classify a frequency band corresponding to the property of the corresponding Fourier domain for each Fourier domain. In an embodiment, the frequency bands are classified into a low frequency band B₁ corresponding to ⅓ of an 0 to an entire band, a frequency band B₂ beneath an intermediate frequency, corresponding to ⅔ of the 0 to the entire band, and an entire frequency band B₃ corresponding to the 0 to the entire band.

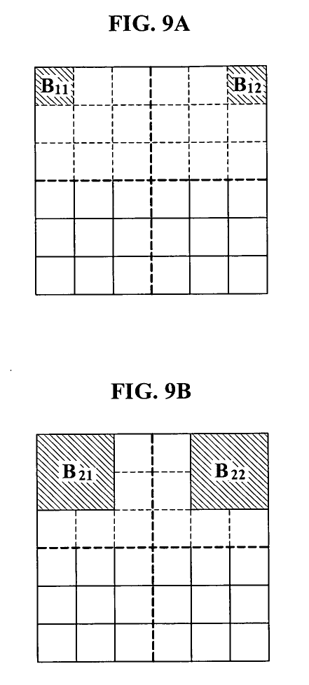

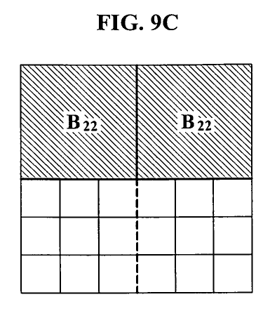

In the face image, the low frequency band is located in an outer side of the Fourier domain and the high frequency band is located in a center part of the Fourier domain. FIG. 9A illustrates the low frequency band B₁ (B₁₁, and B₁₂) classified according to an embodiment of the present embodiment, FIG. 9B illustrates the frequency band B₂ (B₂₁, and B₂₂) beneath the intermediate frequency, and FIG. 9C illustrates the entire frequency band B₃ (B₃₁, and B₃₂) including a high frequency band.

In the R/I domain of the Fourier transform, all Fourier components of the frequency bands B₁, B₂, and B₃ are considered, in operation 731. Since information in the frequency band is not sufficiently included in the magnitude domain, the components of the frequency bands B₁ and B₂, excluding B₃, may be considered, in operation 732. In the phase domain, the component of the frequency band B₁, excluding B₂ and B₃, in which the phase is drastically changed may be considered, in operation 733. Since the value of the phase is drastically changed due to a small variation in the intermediate frequency band and the high frequency band, only the low frequency band may be suitable for consideration.

The face feature extractor 103 may extract the features for the face recognition from the Fourier components of the frequency band, classified for each Fourier domain. In the present embodiment, feature extraction may be performed by using a PCLDA technique, for example.

Linear discriminant analysis (LDA) is a learning method of linear-projecting data to a sub-space maximizing between-class scatter by reducing within-class scatter in a class. For this, a between-class scatter matrix S_{B} indicating between-class distribution and a within-class scatter matrix S_{W} indicating within-class distribution are defined as follows.

$$\text{Equation} 6 \text{:}$$

$${S}_{B} = {\sum }_{i = 0}^{c} {M}_{i} ( {m}_{i} - m ) {( {m}_{i} - m )}^{T}$$

$${S}_{W} = {\sum }_{i = 0}^{c} {\sum }_{{φ}_{k} ∈ {c}_{i}} ( {φ}_{k} - {m}_{i} ) {( {φ}_{k} - {m}_{i} )}^{T}$$

In this case, mᵢ is an average image of ith class cᵢ having Mᵢ number of samples and c is a number of classes. A transformation matrix Wₒₚₜ is acquired satisfying Equation 7, as set forth below.

$$\text{Equation} 7 \text{:}$$

$${W}_{opt} = \text{arg} {max}_{w} \frac{{W}^{T} {S}_{B} W}{{W}^{T} {S}_{W} W} = [ {w}_{1} , {w}_{2} , … , {w}_{n} ]$$

In this case, n is a number of projection vectors and n=min (c−1, N, and M).

Principal component analysis (PCA) may be performed before performing the LDA to reduce dimensionality of a vector to overcome singularity of the within-class scatter matrix. This is called PCLDA in the present embodiment, and performance of the PCLDA depends on a number of eigenspaces used for reducing input dimensionality.

The face feature extractor 103 may extract the features for each frequency band of each Fourier domain according to the described PCLDA technique, in operations 741, 742, 743, 744, 745, and 746. For example, a feature Y_{RIB1} of the frequency band B₁ of the R/I Fourier domain may be acquired by Equation 8, set forth below.

y_{RIB1}=W^{T}_{RIB1}(RI_{B1}−m_{RIB1}) 8

In this case, W_{RIB1} is a transformation matrix of the trained PCLDA to output features with respect to a Fourier component of R/I_{B1} from a learning set according to Equation 7 and m_{RIB1} is an average of features in the RI_{B1}.

In operation 750, the face feature extractor 103 may connect the features output above. Features output from the three frequency bands of the RI domain, features output from the two frequency bands of the magnitude domain, and a feature output from the one frequency band of the phase domain are connected by Equation 9, set forth below.

y_{RI}=[y_{RIB1}y_{RIB2}y_{RIB3}]

y_{M}=[y_{MB1}y_{MB2}]

y_{P}=[y_{PB1}] 9

The features of Equation 9 are finally concatenated as f in Equation 10, shown below, and form a mutually complementary feature.

f=[y_{RI}y_{M}y_{P}] 10

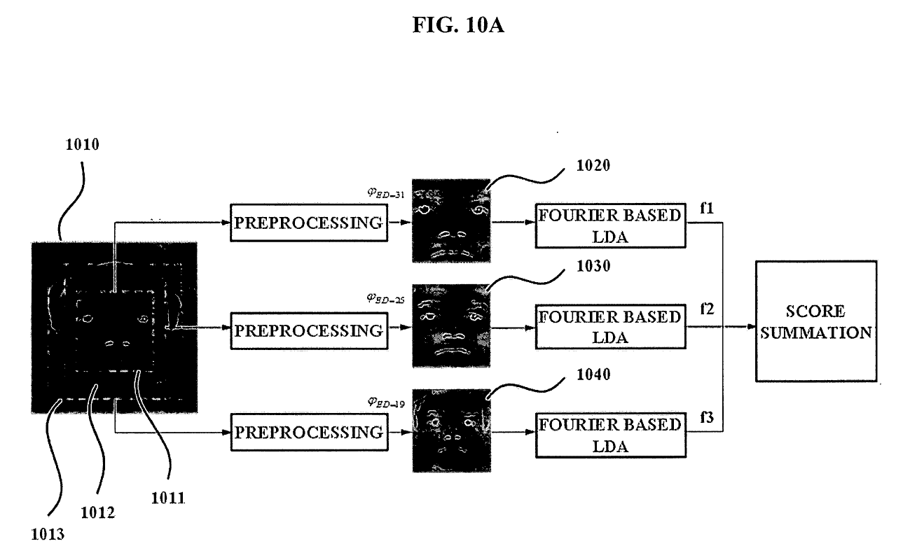

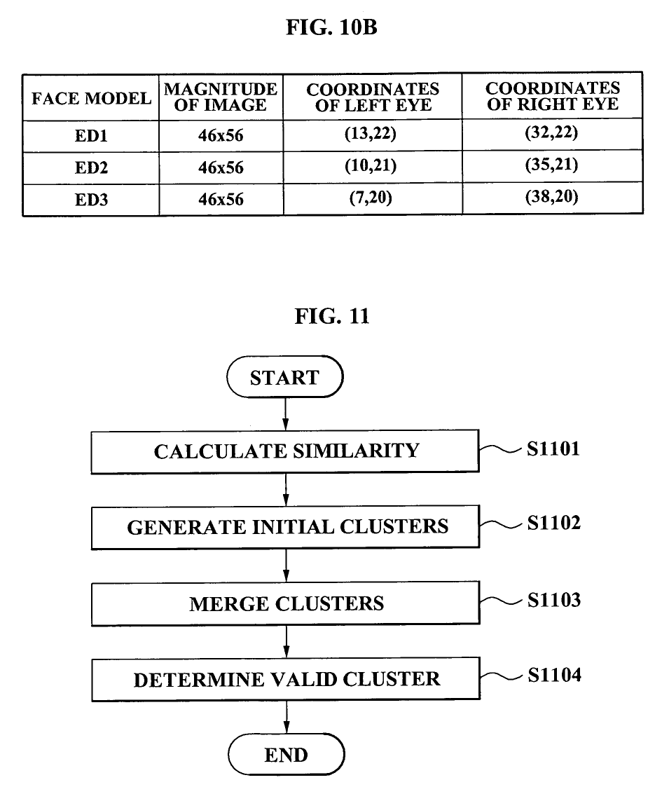

FIGS. 10A and 10B illustrate a method of extracting face feature information from sub-images having different distances between eyes, according to an embodiment of the present invention.

Referring to FIG. 10A, there is an input image 1010. In the input image 1010, an inside image 1011 includes only features inside a face when a head and a background are removed, an overall image 1013 includes an overall form of the face, and an intermediate image 1012 is an intermediate image between the image 1011 and the image 1013.

Images 1020, 1030, and 1040 are results of preprocessing the images 1011, 1012; and 1013 from the input image 1010, such as lighting processing, and resizing to 46×56 images, respectively. As shown in FIG. 10B, according to this example, coordinates of right and left eyes of the images are [(13,22) (32,22)], [(10,21) (35,21)], and [(7,20) (38,20)], respectively.

In a face model ED1 of the image 1020, learning performance is largely reduced when a form of a nose is changed or coordinates of the eyes are in a wrong location of a face, namely, a direction the face is pointed greatly affects performance.

Since an image ED3 1040 includes a full form of the face, the image ED3 1040 is persistent in the pose or wrong eye coordinates and the learning performance is high because a shape of the head is not changed over short periods of time. However, when the shape of the head changes, e.g., for a long period of time, the performance is largely reduced. Since there is relatively little internal information of the face, the internal information of the face is not reflected while training, and therefore general performance may be not high.

Since an ED2 image 1030 suitably includes merits of the image 1020 and the image 1040, head information or background information are not excessively included and most information is corresponding to internal information of the face, thereby showing a most suitable performance.

FIG. 11 illustrates a method of clustering, according to an embodiment of the present invention. The clustering unit 104 may generate a plurality of clusters by grouping a plurality of shots forming video data based on similarity of the plurality of shots. Here, clustering is a technique of grouping similar or related items or points based on that similarity, i.e., a clustering model may have several clusters for differing respective potential events. One cluster may include separate data items representative of separate respective frames that have attributes that could categorize the corresponding frame with one of several different potential events or news items, for example. A second cluster could include separate data items representative of separate respective frames for an event other than the first cluster. Potentially, depending on the clustering methodology, some data items representative of separate respective frames, for example, could even be classified into separate clusters if the data is representative of the corresponding events.

Thus, in operation S1101, the clustering unit 104, for example, may calculate the similarity of the plurality of shots forming the video data. This similarity is the similarity between face feature information, calculated from a key frame of each of the plurality of shots. FIG. 12A illustrates a similarity between a plurality of shots. For example, when a face is detected from a N number of key frames, approximately (N×N/2) number of similarity calculations may be performed for each pair of key frames by using face feature information of the key frames from which a face is detected.

In operation S1102, the clustering unit 104 may generate a plurality of initial clusters by grouping shots whose similarity is not less than a predetermined threshold. As shown in FIG. 12B, shots whose similarity is not less than the predetermined threshold are connected with each other to form a pair of shots. For example, in FIG. 12C, an initial cluster 1201 is generated by using shots 1, 3,4, 7, and 8, an initial cluster 1202 is generated by using shots 4, 7, and 10, an initial cluster 1203 is generated by using shots 7 and 8, an initial cluster 1204 is generated by using a shot 2, an initial cluster 1205 is generated by using shots 5 and 6, and an initial cluster 1206 is generated by using a shot 9.

In operation S1103, the clustering unit 104 may merge clusters including the same shot, from the generated initial clusters. For example, in FIG. 12C, one cluster 1207 including face shots included in the clusters may be generated by merging all the clusters 1201, 1202, and 1203 including the shot 7. In this case, clusters that do not include a commonly included shot are not merged. Thus, according to this embodiment, one cluster may be generated by using shots including the face of the same anchor. For example, cluster 1 may be generated by using shots including an anchor A, and cluster 2 generated by using shots including an anchor B. As shown in FIG. 12C, since the initial cluster 1201, the initial cluster 1202, and the initial cluster 1203 include the same shot 7, the initial cluster 1201, the initial cluster 1202, and the initial cluster 1203 may be merged to generate the cluster 1207. The initial cluster 1204, the initial cluster 1205, and the initial cluster 1206 are represented as a cluster 1208, a cluster 1209, and a cluster 1210 respectively, without any change.

In operation S1104, the clustering unit 104 may remove clusters whose number of included shots is not more than a predetermined value. For example, in FIG. 12D, only valid clusters 1211 and 1212, from clusters 1207 and 1209, respectively remain by removing clusters including only one shot. Namely, the clusters 1208 and 1210 including only one shot in FIG. 12C are removed.

Thus, according to the present embodiment, video data may be segmented by distinguishing an anchor by removing a face shot including a character shown alone, from a cluster. For example, video data of a news program may include faces of various characters such as a correspondent and characters associated with news, in addition to a general anchor, a weather anchor, an overseas news anchor, a sports news anchor, an editorial anchor. According to the present embodiment, there is an effect that the correspondent or characters associated with the news, intermittently shown, are not identified to be the anchor.

FIGS. 13A and 13B illustrates shot mergence, according to an embodiment of the present invention.

The shot merging unit 105 may merge a plurality of shots repeatedly included more than a predetermined numbers for a predetermined amount of time, into one shot by applying a search window to video data. In news program video data, in addition to a case in which an anchor delivers news alone, there is a case in which a guest is invited and the anchor and the guest communicate with each other with respect to one subject. In this case, while the principal character changes, since the shot is with respect to one subject, it is desired to merge the part in which the anchor and the guest communicate with each other into one subject shot. Accordingly, the shot merging unit 105 merges shots included not less than the predetermined number of times, for the predetermined amount of time, into one shot to represent the shots, by applying the search window to the video data. An amount of video data included in the search window may vary, and a number of shots to be merged may also vary.

FIG. 13A illustrates a process in which the shot merging unit 105 merges face shots of a search window into video data, according to an embodiment of the present invention.

Referring to FIG. 13A, the shot merging unit 105 may merge a plurality of shots repeatedly included not less than a predetermined number of times, for a predetermined interval, into one shot by applying a search window 1302 having the predetermined interval. The shot merging unit 105, thus, compares a key frame of a first shot selected from the plurality of shots with a key frame of an nth shot after the first shot and merges shots from the first shot to the nth shot when similarity between the key frame of the first shot and the key frame of the nth shot is not less than a predetermined threshold. When the similarity between the key frame of the first shot and the key frame of the nth shot is less than the predetermined threshold, the shot merging unit 105 compares the key frame of the first shot with a key frame of an n−1th shot after the first frame. In FIG. 13A, shots 1301 are merged into one shot 1303.

FIG. 13B illustrates an example of such a merging of shots by applying a search window to video data, according to an embodiment of the present invention. Referring to FIG. 13B, the shot merging unit 105 may generate one shot 1305 by merging face shots 1304 repeatedly included more than a predetermined number of times for a predetermined interval.

FIGS. 14A, 14B, and 14C are diagrams for comprehending the shot mergence shown in FIG. 13B. Here, FIG. 14A illustrates a series of shots according to a lapse of time in the direction of an arrow, and FIGS. 14B and 14C are tables illustrating matching with an identification number of a segment. In each table, B# indicates a number of a shot, FID indicates an identification number of a face, and indicates that the FID is not identified.

Though a size of a search window 1410 has been assumed to be 8 for understanding the present invention, embodiments of the present invention is not limited thereto, and alternate embodiments are equally available.

When merging shots 1 to 8, belonging to the search window 1410 shown in FIG. 14A, as shown in FIG. 14B, an FID of a first shot (B#=1) may be established as a certain number such as 1. In this case, as similarity between faces, similarity between shots may be calculated by using feature information of the first face shot (B#=1) and face feature information of shots from a second (B#=2) to an eighth (B#=8).

For example, a similarity calculation may be performed by checking similarities between two shots, one from each end. Namely, the similarity calculation may be performed by checking the similarity between two face shots in an order of comparing the face feature information of the first shot (B#=1) with the face feature information of the eighth shot (B#=8), comparing the face feature information of the first shot (B#=1) with face feature information of a seventh shot (B#=7), and comparing the face feature information of the first shot (B#=1) with face feature information of a sixth shot (B#=6).

In this case, when similarity [Sim (F1, F8)] between the first shot (B#=1) and the eighth shot (B#=8) is determined to be less than a predetermined threshold via a result of comparing the similarity [Sim (F1, F8)] between the first shot (B#=1) and the eighth shot (B#=8) with the predetermined threshold, the shot merging unit 105 determines whether similarity [Sim (F1, F7)] between the first shot (B#=1) and the eighth shot (B#=7) is not less than the predetermined threshold. In this case, when the similarity [Sim (F1, F7)] between the first shot (B#=1) and the eighth shot (B#=7) is determined to be not less than the predetermined threshold, all the FIDs from the first shot (B#=1) to the seventh shot (B#=7) are established as 1. In this case, similarities between the first shot (B#=1) and shots from the sixth shot (B#=6) to the second shot (B#=2) may not be compared. Accordingly, the shot merging unit 105 may merge all the shots from the first shot to the seventh shot.

The shot merging unit 105 may, thus, perform the described operations until the FIDs for all the B# are acquired for all the shots by using the face feature information. According to an embodiment, a segment in which the anchor and the guest communicate with each other may be processed as one shot and such shot mergence may be very efficiently processed.

FIG. 15 illustrates a method of generating a final cluster, according to an embodiment of the present invention.

In operation S1501, the final cluster determiner 106 may arrange clusters according to a number of included shots. Referring to FIG. 12D, after merging shots, the cluster 1211 and the cluster 1212 remain. In this case, since the cluster 1211 includes six shots and the cluster 1212 includes two shots, the clusters may be arranged in an order of the cluster 1211 and the cluster 1212.

In operation S1502, the final cluster determiner 106 identifies a cluster including the largest number of shots, from a plurality of clusters, to be a first cluster. Referring to FIG. 12D, since the cluster 1211 includes six shots and the cluster 1212 includes two shots, the cluster 1211 may, thus, be identified as the first cluster.

In operations S1503 through S1507, the final cluster determiner 106 may identify a final cluster by comparing the first cluster with clusters excluding the first cluster. Hereinafter, operations S1502 through S1507 will be described in greater detail.

In operation S1503, the final cluster determiner 106 identifies the first cluster to be a temporary final cluster. In operation S1504, a first distribution value of time lags between shots included in the temporary cluster is calculated.

In operation S1505, the final cluster determiner 106 may sequentially merge shots included in other clusters, excluding the first cluster, with the first cluster and identify a smallest value from distribution values of merged clusters to be a second distribution value. In detail, the final cluster determiner 106 may select one of the other clusters, excluding the temporary final cluster, and merge the cluster with the temporary final cluster (a first operation). A distribution value of the time lags between the shots included in the merged cluster may further be calculated (a second operation). The final cluster determiner 106 identifies the smallest value from the distribution values calculated by performing the first operation and the second operation for all the clusters, excluding the temporary final cluster, to be the second distribution value and identifies the cluster, excluding the temporary final cluster, whose second distribution value is calculated, to be a second cluster.

In operation S1506, the final cluster determiner 106 may compare the first distribution value with the second distribution value. When the second distribution value is less than the first distribution value, as a result of the comparison, the final cluster determiner 106 may generate a new temporary final cluster by merging the second cluster and the temporary final cluster, in operation S1507. The final cluster may be generated by performing such merging for all of the clusters accordingly. However, when the second distribution is not less than the first distribution value, the final cluster may be generated without merging the second cluster.

The final cluster determiner 106 may further extract shots included in the final cluster. In addition, the final cluster determiner 106 may identify the shots included in the final cluster to be a shot in which an anchor is shown. Namely, from a plurality of shots forming video data, the shots included in the final cluster may be identified to be the shot in which the anchor is shown, according to the present embodiment. Accordingly, when the video data is segmented based on the shots in which the anchor is shown, namely, the shot included in the final cluster, the video data may be segmented by news segments.

The face model generator 107 identifies a shot, which is included a greatest number of times in a plurality of clusters identified to be the final cluster, to be a face model shot. Since a character of the face model shot is most frequently shown from a news video, the character may be identified to be the anchor.

FIG. 16 illustrates a process of merging clusters by using time information of shots, according to an embodiment of the present invention.

Referring to FIG. 16, the final cluster determiner 106 may calculate a first distribution value of time lags T1, T2, T3, and T4 between shots 1601 included in a first cluster including a largest number of shots. Including shots included in the first cluster and simultaneously included in one cluster from other clusters, a distribution value of time lags T5, T6, T7, T8, T9, T10, and T11 between shots 1602 may be calculated. In FIG. 16, a time lag between a first shot and a second shot included in the first cluster is T1 may be calculated. Since a shot 3 included in another cluster is included between the shot 1 and the shot 2, a time lag T5 between the shot 1 and the shot 3 and a time lag T6 between the shot 3 and the shot 2 may be used for calculating the distribution value. Shots included in the other clusters, excluding the first cluster, may be sequentially merged with the first cluster, and a smallest value of distribution values of the merged clusters identified to be a second distribution value.

Further, when the second distribution value is less than the first distribution value, the cluster identified to be the second distribution value may be merged first. Accordingly, the merging for all the clusters may be performed and a final cluster generated. However, when the second distribution value is more than the first distribution value, the final cluster may be generated without merging the second cluster.

Thus, according to an embodiment of the present invention, video data can be segmented by classifying face shots of an anchor equally-spaced in time.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

One or more embodiments of the present invention provides a video data processing method, medium, and system capable of segmenting video data by a semantic unit that does not include a certain video/audio feature.

One or more embodiments of the present invention further provides a video data processing method, medium, and system capable of segmenting/summarizing video data by a semantic unit, without previously storing face/voice data with respect to a certain anchor in a database.

One or more embodiments of the present invention also provides a video data processing method, medium, and system which do not segment a scene in which an anchor and a guest are repeatedly shown in one theme.

One or more embodiments of the present invention also provides a video data processing method, medium, and system capable of segmenting video data for each anchor, namely, each theme, by using a fact that an anchor may be repeatedly shown, equally spaced in time, more than other characters.

One or more embodiments of the present invention also provides a video data processing method, medium, and system capable of segmenting video data by identifying an anchor by removing a face shot including a character shown alone, from a cluster.

One or more embodiments of the present invention also provides a video data processing method, medium, and system capable of precisely segmenting video data by using a face model generated in a process of segmenting the video data.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A video data processing system, comprising:
a clustering unit to generate a plurality of clusters by grouping a plurality of shots forming video data, the grouping of the plurality of shots being based on similarities among the plurality of shots; and
a final cluster determiner to identify a cluster having a greatest number of shots from the plurality of clusters to be a first cluster and identifying a final cluster by comparing other clusters with the first cluster.

2. The system of claim 1, wherein the clustering unit controls a merging of clusters including a same shot from the merged clusters, and a removing of a cluster from the merged clusters whose number of included shots are not more than a predetermined number.

3. The system of claim 1, wherein the similarity among the plurality of shots is a similarity among face feature information calculated in a key frame of each of the plurality of shots.

4. The system of claim 1, further comprising:
a scene change detector to segment the video data into the plurality of shots and identifying a key frame for each of the plurality of shots;
a face detector to detect a respective face for each respective key frame; and
a face feature extractor to extract respective face feature information from each respective detected face.

5. The system of claim 4, wherein the clustering unit calculates a similarity among face feature information of each key frame of each of the plurality of shots.

6. The system of claim 4, wherein each key frame of each of the plurality of shots is a frame after a predetermined amount of time from a start frame of each of the plurality of shots.

7. The system of claim 4, wherein the face feature extractor controls a generating of multi-sub-images with respect to an image of the respective detected faces, an extracting of Fourier features for each of the multi-sub-images by Fourier transforming the multi-sub-images, and a generating of respective face feature information by combining the Fourier features.

8. The system of claim 7, wherein the multi-sub-images are a plurality of images that have a same size and are with respect to a same image of the respective detected faces, but with distances between respective eyes in respective multi-sub-images being different.

9. The system of claim 1, further comprising a shot merging unit to control a identifying of a key frame for each of the plurality of shots, a comparing of a key frame of a first shot selected from the plurality of shots with a key frame of an Nth shot after the first shot, and a merging of all shots from the first shot to the Nth shot when similarity among the key frame of the first shot and the key frame of the Nth shot is not less than a predetermined threshold.

10. The system of claim 9, wherein the shot merging unit compares the key frame of the first shot with a key frame of an N−1th shot when the similarity among the key frame of the first shot and the key frame of the Nth shot is less than the predetermined threshold.

11. The system of claim 1, wherein the final cluster determiner controls a first operation of determining the first cluster to be a temporary final cluster, and a second operation of generating a first distribution value of time lags between shots included in the temporary final cluster.

12. The system of claim 11, wherein the cluster determiner further controls a third operation of selecting one of the plurality of clusters, excluding the temporary final cluster, and merging the selected cluster with the temporary final cluster, a fourth operation of calculating a distribution value of time lags between shots included in the merged cluster, and a fifth operation of determining a smallest value from the distribution values calculated by performing the third operation and the fourth operation for all the clusters, excluding the temporary final cluster, to be a second distribution value, and identifying a cluster whose second distribution value is calculated to be a second cluster.

13. The system of claim 12, wherein the final cluster determiner further controls a sixth operation of generating a new temporary final cluster by merging the second cluster with the temporary final cluster when the second distribution value is less than the first distribution value.

14. The system of claim 1, wherein the final cluster determiner identifies the shots included in the final cluster to be a shot in which an anchor is included.

15. The system of claim 1, further comprising a face model generator to identify a shot, which is most often included from the shots included in a plurality of clusters that is identified to be the final cluster, to be a face model shot.

16. A method of processing video data, comprising:
calculating a first similarity among a plurality of shots forming the video data;
generating a plurality of clusters by grouping shots whose first similarity is not less than a predetermined threshold;
selectively merging the plurality of shots based on a second similarity among the plurality of shots;
identifying a cluster including a greatest number of shots from the plurality of clusters, to be a first cluster;
identifying a final cluster by comparing the first cluster with clusters excluding the first cluster; and
extracting shots included in the final cluster.

17. The method of claim 16, wherein the calculating of the first similarity among the plurality of shots comprises:
identifying a key frame for each of the plurality of shots;
detecting a respective face from each key frame;
extracting respective face feature information from respective detected faces; and
calculating similarities among the respective face feature information of the respective key frame of each of the plurality of shots.

18. The method of claim 16, further comprising:
merging clusters including a same shot, from the generated clusters; and
removing a cluster from the merged clusters whose number of the included shots is not more than a predetermined value.

19. The method of claim 16, wherein the merging the plurality of shots comprises:
identifying a key frame for each of the plurality of shots;
comparing a key frame of a first shot selected from the plurality of shots with a key frame of an Nth shot after the first shot; and
merging the first shot through the Nth shot when similarities between the key frame of the first shot and the key frame of the Nth shot is not less than a predetermined threshold.

20. A method of processing video data, comprising:
calculating similarities among a plurality of shots forming the video data;
generating a plurality of clusters by grouping shots whose similarity is not less than a predetermined threshold;
merging clusters including a same shot, from the generated plurality of clusters; and
removing a cluster from the merged clusters whose number of included shots is not more than a predetermined value.

21. The method of claim 20, wherein the similarity between the plurality of shots is a similarity among respective face feature information calculated from a respective key frame of each of the plurality of shots.

22. The method of claim 20, wherein the calculating of the similarities among a plurality of shots comprises:
identifying a key frame for each of the plurality of shots;
detecting respective faces from a respective key frame;
extracting face feature information from the respective detected faces; and
calculating similarities among the face feature information of the respective key frame of each of the plurality of shots.

23. The method of claim 22, wherein, in the identifying of the key frame for each of the plurality of shots, a frame after a predetermined amount of time from a start frame of each of the plurality of shots is identified to be the respective key frame.

24. The method of claim 22, wherein the extracting of the face feature information from the respective detected faces comprises:
generating multi-sub-images with respect to an image of the respective detected faces;
extracting Fourier features for each of the multi-sub-images by Fourier transforming the multi-sub-images; and
generating the respective face feature information by combining the Fourier features.

25. The method of claim 24, wherein the multi-sub-images are a plurality of images that have a same size and are with respect to a same image of the respective detected faces, with distances between respective eyes in the respective multi-sub-images being different.

26. The method of claim 24, wherein the extracting of Fourier features for each of the multi-sub-images comprises:
Fourier transforming the multi-sub-images;
classifying a result of the Fourier transforming for each Fourier domain;
extracting a feature for each classified Fourier domain by using a corresponding Fourier component; and
generating the Fourier features by connecting the extracted features extracted for each of the Fourier domains.

27. The method of claim 26, wherein:
the classifying of the result of the Fourier transforming for each Fourier domain comprises classifying a frequency band according to the feature of each of the Fourier domains; and
the extracting of the feature for each classified Fourier domain comprises extracting the feature by using a Fourier component corresponding to the frequency band classified for each of the Fourier domains.

28. The method of claim 27, wherein the extracted feature is extracted by multiplying a result of subtracting an average Fourier component of the corresponding frequency band from the Fourier component of the frequency band, by a previously trained transformation matrix.

29. The method of claim 28, wherein the transformation matrix is dynamically updated to output the feature when the Fourier component is input according to a PCLDA algorithm.

30. A method of processing video data, comprising:
segmenting the video data into a plurality of shots;
identifying a key frame for each of the plurality of shots;
comparing a key frame of a first shot selected from the plurality of shots with a key frame of an Nth shot after the first shot; and
merging the first shot through the Nth shot when similarities among the key frame of the first shot and the key frame of the Nth shot is not less than a predetermined threshold.

31. The method of claim 30, further comprising comparing the key frame of the first shot with a key frame of an N−1th shot when the similarities among the key frame of the first shot and the key frame of the Nth shot is less than the predetermined threshold.

32. A method of processing video data, comprising:
segmenting the video data into a plurality of shots;
generating a plurality of clusters by grouping the plurality of shots, the grouping being based on similarities among the plurality of shots;
identifying a cluster including a greatest number of shots from the plurality of clusters, to be a first cluster;
identifying a final cluster by comparing the first cluster with clusters excluding the first cluster; and
extracting shots included in the final cluster.

33. The method of claim 32, wherein the identifying of the final cluster comprises:
identifying the first cluster to be a temporary final cluster; and
generating a first distribution value of time lags between shots included in the temporary final cluster.

34. The method of claim 33, wherein the identifying of the final cluster further comprises:
selecting one of the plurality of clusters, excluding the temporary final cluster, and merging the selected cluster with the temporary final cluster;
calculating a distribution value of time lags between shots included in the merged cluster; and
identifying a smallest value from distribution values calculated by performing selecting and merging of the cluster and the calculation of the distribution value for all clusters, excluding the temporary final cluster, to be a second distribution value, and identifying a cluster whose second distribution value is calculated as a second cluster.

35. The method of claim 34, wherein the identifying of the final cluster further comprises generating a new temporary final cluster by merging the second cluster with the temporary final cluster when the second distribution value is less than the first distribution value.

36. The method of claim 32, further comprising identifying a shot that is most often included from shots included in a plurality of clusters that is identified to be the final cluster, to be a face model shot.

37. The method of claim 32, further comprising determining shots included in the final cluster to be a shot in which an anchor is shown.

38. At least one medium comprising computer readable code to control at least one processing element to implement a method of processing video data, the method comprising:
calculating a first similarity among a plurality of shots forming the video data;
generating a plurality of clusters by grouping shots whose first similarity is not less than a predetermined threshold;
selectively merging the plurality of shots based on a second similarity among the plurality of shots;
identifying a cluster including a greatest number of shots from the plurality of clusters, to be a first cluster;
identifying a final cluster by comparing the first cluster with clusters excluding the first cluster; and
extracting shots included in the final cluster.

39. The medium of claim 38, wherein the method further comprises:
merging clusters including a same shot, from the generated plurality of clusters; and
removing a cluster from the merged clusters whose number of included shots is not more than a predetermined value.

40. At least one medium comprising computer readable code to control at least one processing element to implement a method of processing video data, the method comprising:
calculating similarities among a plurality of shots forming the video data;
generating a plurality of clusters by grouping shots whose similarity is not less than a predetermined threshold;
merging clusters including a same shot, from the generated plurality of clusters; and
removing a cluster from the merged clusters whose number of included shots is not more than a predetermined value.

41. The medium of claim 40, wherein the calculating of the similarities among the plurality of shots comprises:
identifying a key frame for each of the plurality of shots;
detecting respective faces from a respective key frame;
extracting face feature information from the respective detected faces; and
calculating similarities among the face feature information of the respecitve key frame of each of the plurality of shots.

42. At least one medium comprising computer readable code to control at least one processing element to implement a method of processing video data, the method comprising:
segmenting the video data into a plurality of shots;
identifying a key frame for each of the plurality of shots;
comparing a key frame of a first shot selected from the plurality of shots with a key frame of an Nth shot after the first shot; and
merging the first shot through the Nth shot when similarities among the key frame of the first shot and the key frame of the Nth shot is not less than a predetermined threshold.

43. The medium of claim 42, wherein the method further comprises comparing the key frame of the first shot with a key frame of an N−1th shot when the similarities among the key frame of the first shot and the key frame of the Nth shot is less than the predetermined threshold.

44. At least one medium comprising computer readable code to control at least one processing element to implement a method of processing video data, the method comprising:
segmenting the video data into a plurality of shots;
generating a plurality of clusters by grouping the plurality of shots, the grouping being based on similarities among the plurality of shots;
identifying a cluster including a greatest number of shots from the plurality of clusters, to be a first cluster;
identifying a final cluster by comparing the first cluster with clusters excluding the first cluster; and
extracting shots included in the final cluster.
